(19) United States
(12) Patent Application Publication
(10) Pub. No.: US 2002/0059115 A1
(43) Pub. Date: May 16, 2002

(54) Method and configuration of marketing via network

(75) Inventor: Mitsunori Tsujino, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/829,047

(22) Filed: Apr. 10, 2001

(30) Foreign Application Priority Data
Nov. 14, 2000 (JP) 2000-346748(P)

(51) Int. Cl. G06F 17/60

(52) U.S. Cl. 705/27

(57) ABSTRACT

A main computer on a maker side carries out a grading selling of products managed by identification numbers in response to a request from a user terminal. A user is provided with grading information of the products. The main computer receives a purchase order from a user terminal with a requirement that the user is a registered member. The main computer also receives complaint information and inquiries from the user terminal. Data in a product management file is used to reconfigure tests before shipment.

### BACKGROUND OF THE INVENTION

1. FIELD OF THE INVENTION

The present invention relates to a method and a device for marketing, and more particularly, to a method and a configuration for intercommunication via a network.

2. DESCRIPTION OF THE BACKGROUND ART

Conventionally, semiconductor products are sold to consumers by agencies or distributors after various operation tests followed by an additional acceleration test (aging test) for eliminating defectives. Specifically, as shown in FIG. 19, after a product is manufactured (S51), the product is subjected to an operation test and an acceleration test in a wafer state (S52), is assembled (S53), and the assembled product is further subjected to operation and acceleration tests (S54) before shipment (S55).

The work for eliminating defectives is called screening. Of all the screening steps, the aging step is particularly directed to eliminate an initial failure of the product. An example of the aging step is a high-temperature acceleration test (a burn-in test).

Referring to FIGS. 20A and 20B, failures are classified into the initial failure, a random failure and a wear-out failure. In FIG. 20A, a failure rate λ represents a value obtained by dividing the number of products failed during a period At by the number of products operating normally, in FIG. 20B, and a failure density function f represents a value obtained by dividing the number of products failed during a period Δt by total number of the products.

The initial failure occurs at an early stage in the use of a product and is attributable to some potential defects that has appeared in the manufacturing process of the product. The failure rate of the initial failure is characterized by decreasing with time.

Thus, screening is a step of eliminating the products with low reliability level (definition: probability by which systems, devices, components and so forth achieve defined functions for an intended period under defined conditions. (JIS (Japanese Industrial Standard)(Z8115))

Incidentally, the reliability (quality) of the products is generally defined by intended purposes. Specifically, as shown in FIG. 21, conventional quality is roughly classified into three kinds, such as for high reliability, for general industries, and for general consumers. The products are shipped to the market only when verification is made by test evaluation for which the defined value “for high reliabilities” is satisfied for important devices, the defined value “for general industries” is satisfied for industrial devices, and the defined value “for general consumers” is satisfied for consumer devices. The values indicated in the column of quality in the table shown in FIG. 21 is merely an example.

However, the defined value to be satisfied by consumer devices sold to general users is arbitrarily determined by a maker side or by a maker side and an intermediary market, and the current situation is that only perfect products, which has passed the tests under conditions far exceeding the operating environment of the users, are shipped.

Thus, conventionally, careful screening was required for the consumer devices to increase the reliability thereof, irrespective of the needs of the users, resulting in problems in that a limit on shortening of test time is beginning to be seen and that lower cost of the product is difficult to realize.

Further, an agency or a distributor is involved between a maker and a user, so that the system in which the user passively buys the product could not easily provide the maker side with recognition of the needs of the user. This has caused a problem in that the maker side could not grasp what kind of products are demanded by general users, resulting in difficulties in rapid offering of the service as required by the users.

### SUMMARY OF THE INVENTION

Therefore, the present invention provides a marketing method enabling marketing that reflects demands of users and a marketing device for realizing the marketing method.

According to one aspect of the present invention, a method of marketing includes the steps of managing data using an identification number per product; transmitting grading information concerning the product to a user terminal via a network; registering a new user as a member; receiving a purchase order from the user terminal of the user registered as a member via the network; and reflecting a reaction of the user for the product ordered.

Preferably, the grading information includes information indicating a summary of a conducted test, and a reliability level and a cost allocated in accordance with the conducted test.

More preferably, the step of managing data includes the steps of editing a test-related file in which the identification number and information concerning the conducted test are registered per product, and editing a product information file in which the identification number and the grading information are registered per product. The step of transmitting grading information concerning the product includes the step of retrieving the product information file in response to a request from the user terminal.

More preferably, the step of registering as a member includes the step of allocating an unique user identification number per user while editing a user management file managing user information per user identification number.

More preferably, the step of receiving the purchase order includes the steps of editing a purchase product file in which an identification number of a product for which the purchase order is received is registered per user, and editing a purchase history file in which a warranty period and the identification number are registered per product for which the purchase order is received.

More preferably, the step of reflecting the reaction of the user includes the steps of receiving complaint information from the user terminal, and retrieving a history of a product within the warranty period among products ordered by the user who transmitted the complaint information.

More preferably, the step of reflecting the reaction of the user includes the steps of receiving complaint information from the user terminal, editing a complaint information file based on the complaint information, and reconfiguring a test conducted on the product using data in the complaint information file.

More preferably, the step of reflecting the reaction of the user includes the step of receiving an inquiry from the user terminal.

According to a further aspect of a present invention, a device for marketing includes a product management file in which data is registered using an identification number per product; a product information file in which grading information is registered per product; a user registration file in which user information is registered per user identification number; an input/output control unit for transmitting and receiving data to/from a user terminal via a network; and a processing unit transmitting data in the product information file to the user terminal, applying the user identification number to a new user, receiving a purchase order from the user terminal of the user to which the user identification is applied, and reflecting a reaction of a user for the product ordered.

Preferably, the grading information includes information indicating a summary of a conducted test, and a reliability level and a cost allocated in accordance with the conducted test.

More preferably, the device for marketing further includes a test-related file, editable with control of the processing unit and to which the identification number and the information concerning the conducted test, are registered. The device for marketing further includes a purchased product file, editable with control of the processing unit and to which an identification number of a product for which the purchase order is received, is registered per user; and a purchase history file to which a warranty period and the identification number are registered per product for which the purchase order is received.

More preferably, the processing unit retrieves a history of a product within the warranty period among products ordered by the user who sent the complaint information, upon reception of the complaint information from the user terminal.

More preferably, the device for marketing further includes a complaint information file in which the complaint information transmitted from the user terminal is stored, the processing unit reconfiguring a test to be conducted for the product using data in the complaint information file.

More preferably, the processing unit processes for receiving an inquiry from the user terminal to which the user identification number is applied.

Thus, according to the method and the device for marketing in the present invention, products are sold by grading the products with different reliability levels to provide users with the products at low cost. Further, detailed product information including the reliability levels and the cost can be provided to the user via a network.

The user side can casually (without a distributor) obtain accurate product information via the network. The user can also easily make a purchase order via the network.

The maker side stores purchase history of the user to grasp the degree of the reliability demanded by the user for a product. Further, the maker can easily reconsider the grading, i.e. test configuration, in accordance with the demand of the user. This enables further lowering of the cost of the product.

In addition, the maker side can receive complaint information via the network, allowing immediate attention to already-sold malfunctioning products. Moreover, the maker side can efficiently summarize and analyze the data for the defectives. Furthermore, the maker side can also receive inquiries from the user via the network, allowing immediate answering to the user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a marketing system 1000 according to an embodiment of the present invention;

FIG. 2 is a diagram illustrating a configuration of an identification number ID applied to a product according to an embodiment of the present invention;

FIG. 3 is a schematic block diagram illustrating a main computer 1 according to an embodiment of the present invention;

FIG. 4 illustrates a data configuration of a product information file 13 according to an embodiment of the present invention;

FIG. 5 illustrates a data configuration of a user registration file 14 according to an embodiment of the present invention;

FIG. 6 illustrates a data configuration of a purchased-product file 15 according to an embodiment of the present invention;

FIG. 7 illustrates a data configuration of a test-related file 10 according to an embodiment of the present invention;

FIG. 8 illustrates a data configuration of a purchase history file 11 according to an embodiment of the present invention;

FIG. 9 illustrates a data configuration of a complaint-related file 12 according to an embodiment of the present invention;

FIG. 10 shows a relation between the evaluation of reliability and presence/absence of an acceleration operation test according to an embodiment of the present invention;

FIG. 11 illustrates grading selling according to an embodiment of the present invention;

FIG. 12 is a block diagram showing a configuration of a user terminal 3 according to an embodiment of the present invention;

FIGS. 13 and 14 show flow charts illustrating process procedure of a marketing system according to an embodiment of the present invention;

FIGS. 15 to 17 show transition of a screen displayed on a display unit 95;

FIG. 18 illustrates relations among makers, users and distributors according to an embodiment of the present invention;

FIG. 19 is a flow chart showing a process from manufacturing to shipment for a conventional semiconductor product;

FIGS. 20A and 20B illustrate failures of a semiconductor product; and

FIG. 21 illustrates conventional reliability levels.

### DESCRIPTION OF THE PREFERRED EMBODIMENTS

An embodiment of the present invention is described with reference to the drawings. Same or corresponding portions in the drawings are denoted by the same reference numbers or characters, and the descriptions therefor will not be repeated.

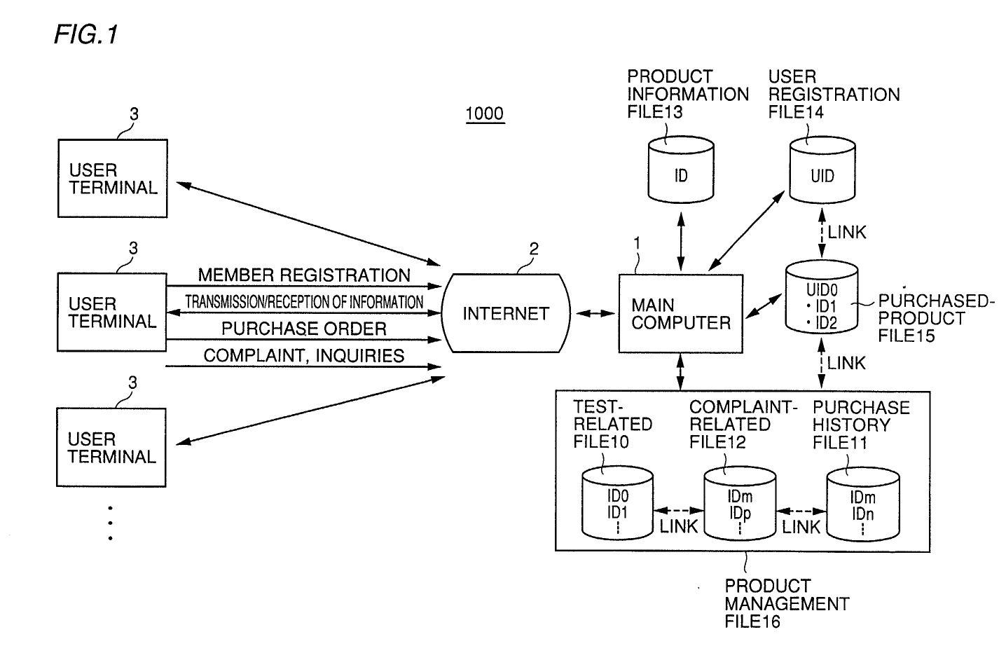

A system 1000 realizing a marketing method according to an embodiment of the present invention is described. Referring to FIG. 1, a user terminal 3 is connected to a main computer 1 on a maker side via the Internet (a network) 2.

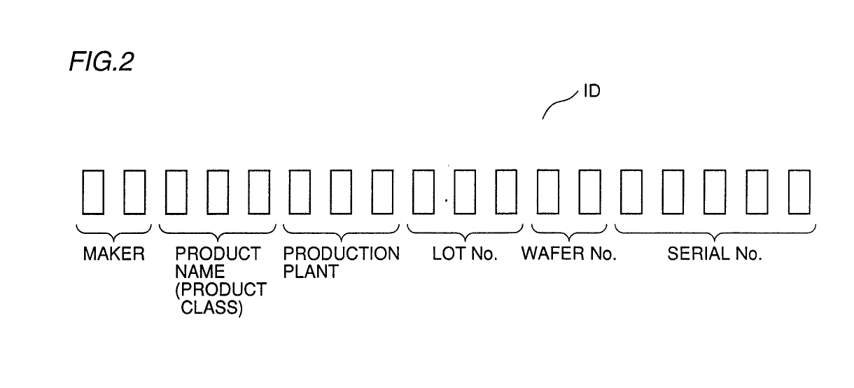

A product is provided with an identification number ID, which is used as a key for the management of product information in main computer 1. The identification number includes, as shown in FIG. 2 for example, a combination of numbers and codes representing a maker, a product name, a production plant, a lot number, a wafer number and a serial number.

Referring to FIG. 1, a product to be sold is evaluated for its reliability level in accordance with the content of the test conducted before shipment, and is graded. Information related to the test is registered in a test-related file 10 and a product information file 13 via main computer 1.

Main computer 1 transmits the contents of product information file 13 to user terminal 3 in response to a request from user terminal 3. Product information file 13 allows the user to browse the specification, reliability level, cost or the like for each product to be sold.

A user who registered as a member makes a purchase order for a product or receives after-sales service via the Internet 2. The registered user is provided with a unique user identification number UID. Main computer 1 manages individual information of the user using a user registration file 14.

Purchase order transmitted from user terminal 3 is transferred to main computer 1 via the Internet 2. Main computer 1 registers purchase history of each user into purchased-product file 15.

Main computer 1 executes an ordering process based on identification number ID of an ordered product and user identification number UID. At that time, main computer 1 updates purchase history file 11 in which the history of the order is saved. Here, the method of payment for the product is not limited.

After-sales service includes complaint processing, e.g. adjustment for returns, and answering for inquiries. Complaint information transmitted from user terminal 3 is transferred to main computer 1 via the Internet 2. Main computer 1 analyzes the complaint information, updates a complaint-related file 12 in which history of the complaint information is saved, and determines action to be taken.

The inquiries input to user terminal 3 is transferred to main computer 1 via the Internet 2.

A product management file 16 including test-related file 10, purchase history file 11 and complaint-related file 12, product information file 13, and purchased-product file 15 are linked together using identification number ID as a key. User registration file 14 and purchased-product file 15 are linked together using user identification number UID as a key. In the drawings, the reference characters ID and IDk (k=0, 1, . . . ) denote identification numbers, and the reference characters UID and UIDk (k=0, 1, . . . ) denote user identification numbers.

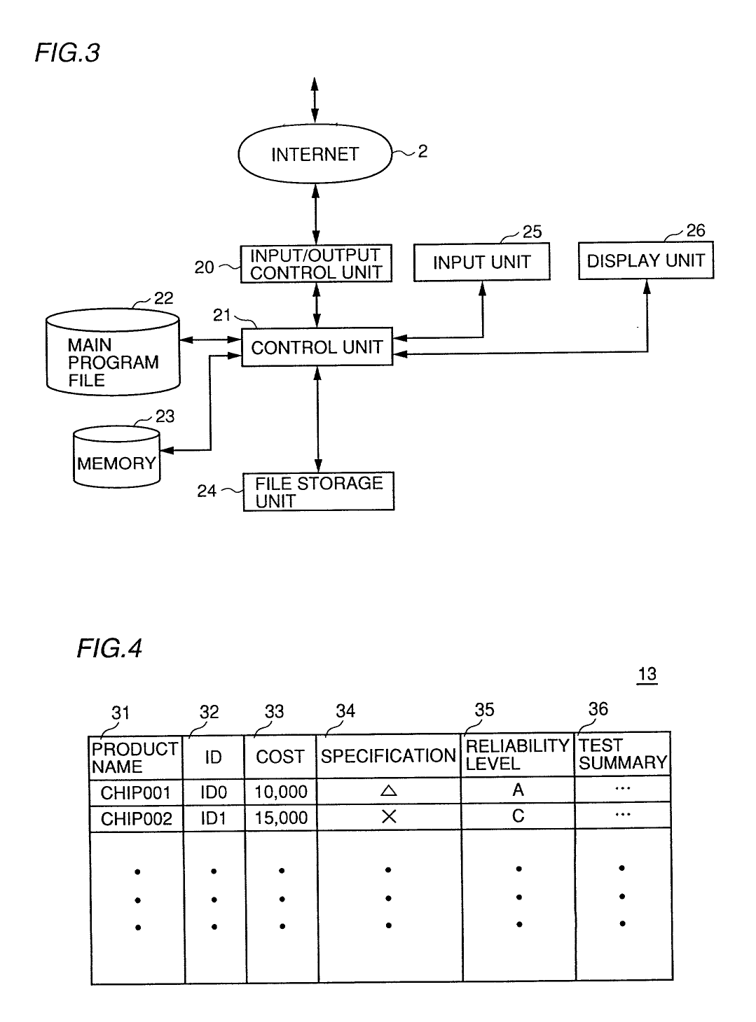

The outline of main computer 1 is described with reference to FIG. 3. Main computer 1 includes an input/output control unit 20 for transmitting and receiving information to/from the Internet 2, a control unit 21 controlling each unit and also controlling program execution, a main program file 22 storing a main program for executing a process described later, a memory 23 storing data during program execution, a file storage unit 24, an input unit (keyboard, mouse or the like) 25 for inputting data, and a display unit 26 for displaying data.

With the control by control unit 21, main computer 1 realizes a data communication function via the Internet 2, an information retrieval function, an information screen presentation function, a file edit function and so forth.

File storage unit 24 stores test-related file 10, purchase history file 11, complaint-related file 12, product information file 13, user registration file 14 and a purchased-product file 15.

Referring to FIG. 4, data including a product name 31, an identification number (ID) 32, a cost 33, a specification 34, a reliability level 35 and a test summary 36 summarizing the test conducted before shipment is registered into product information file 13 per product.

Referring to FIG. 5, data including a member name (user name) 40, a user identification number (UID) 41, an address 42, a communication method (e.g. telephone number, E-mail address) 43, a credit card number 44 and a password 45 is registered into user registration file 14 per user.

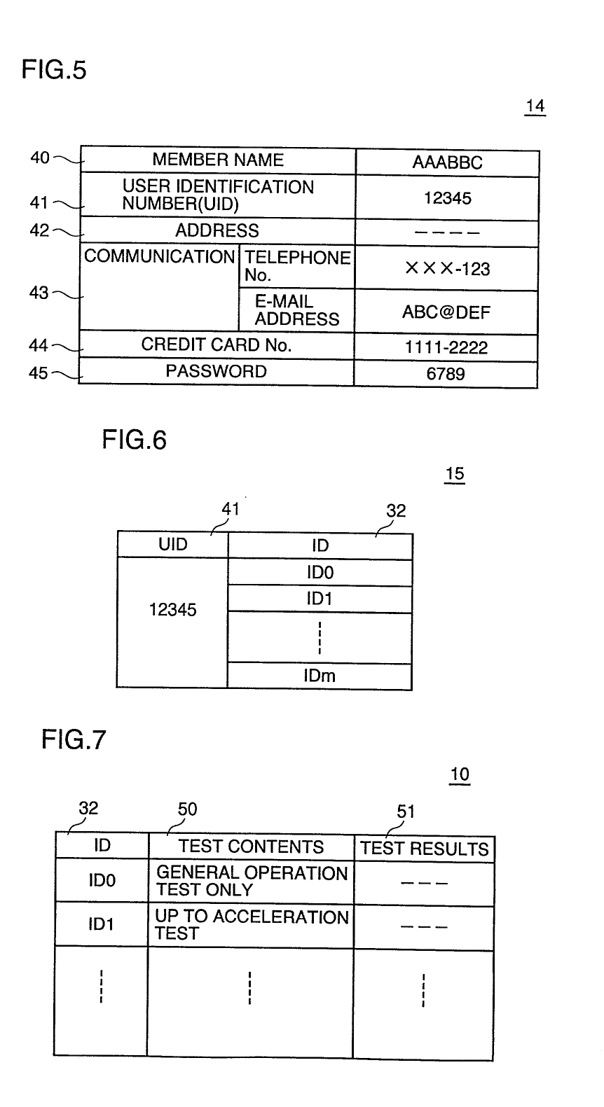

Referring to FIG. 6, identification number (ID) 32 of an ordered product is registered into purchased-product file 15 per user identification number (UID) 41.

Referring to FIG. 7, data including test contents 50 and test results 51 is registered into test-related file 10 per identification number (ID) 32.

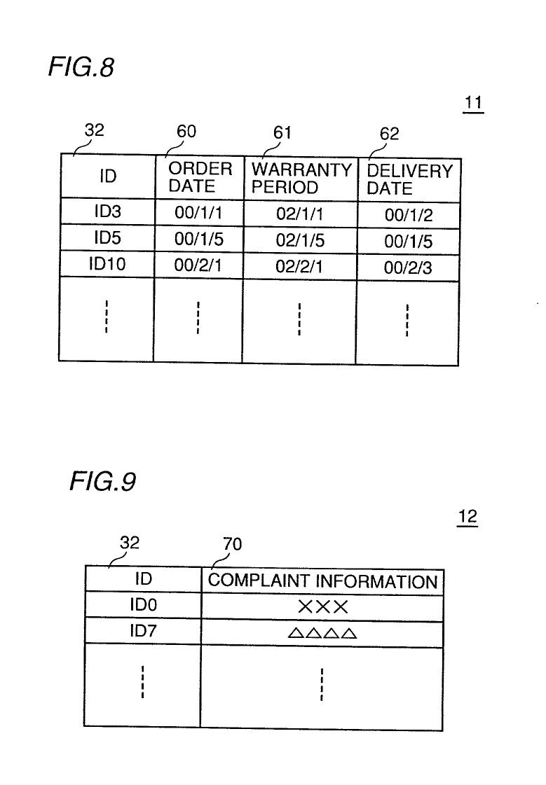

Referring to FIG. 8, data including an order-receiving date 60, product warranty period 61 and product delivery date 62 is registered into purchase history file 11 per identification number (ID) 32.

Referring to FIG. 9, an identification number (ID) 32 and complaint information 70 are registered into complaint-related file 12.

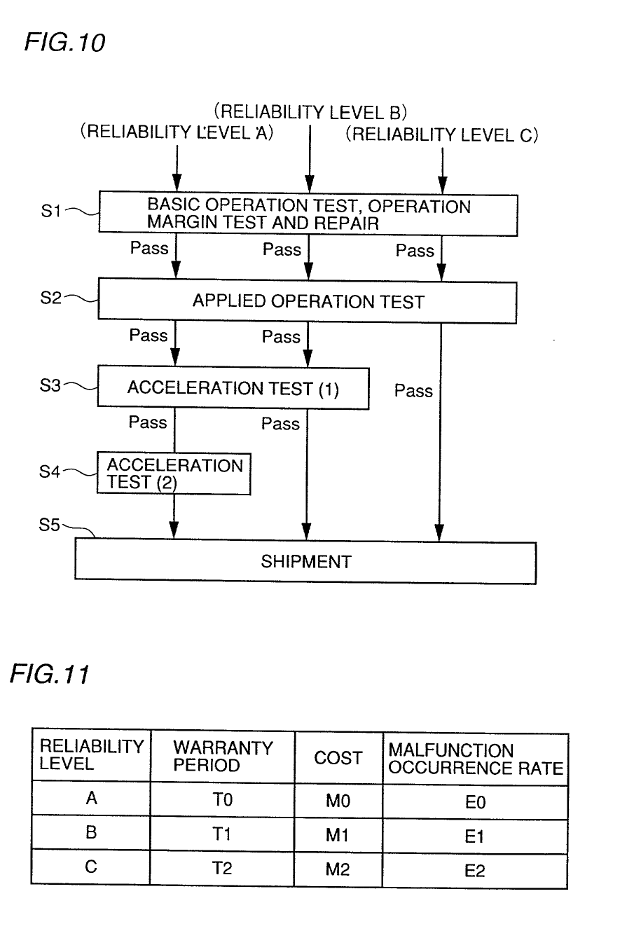

Evaluation of reliability level (grading of products) according to an embodiment of the present invention is now described with reference to FIGS. 10 and 11. In the embodiment of the present invention, grading selling of products is performed by changing test configurations to provide differences in the reliability levels of the products.

An example where different reliability levels are provided by an acceleration operation test is described with reference to FIG. 10. All the products are subjected to a basic operation test, an operation margin test and a repair S1, followed by an applied operation test S2 for further validation of the operation.

The products that passed (“Pass”) the basic operation test, operation margin test and repair S1, applied operation test S2, acceleration operation test (1) S3 and acceleration test (2) S4, and to be shipped S5, are evaluated as having a reliability level A.

The products that passed the basic operation test, operation margin test and repair S1, applied operation test S2 and acceleration operation test (1) S3, and to be shipped S5 without execution of acceleration test (2) S4 are evaluated as having a reliability level B.

The products that passed the basic operation test, operation margin test and repair S1, applied operation test S2, and to be shipped S5 without execution of tests S3 and S4 are evaluated as having a reliability level C.

The reliability levels are reflected to warranty periods and cost. For example, as shown in FIG. 11, a product with the reliability level A would have a warranty period of T0, a cost of M0 and a malfunction occurrence rate of E0; a product with the reliability level B would have a warranty period of T1, a cost of M1 and a malfunction occurrence rate of E1; and a product with the reliability level C would have a warranty period of T2, a cost of M2 and a malfunction occurrence rate of E2.

Differentials are respectively provided in the number of the test steps between the malfunction occurrence rates and between the warranty periods (e.g. E0<E1<E2 and T0≦T1≦T2), since the number of test steps affects the malfunction occurrence rates. The cost of the product with the reliability level B is made lower than the that of the product with the reliability level A which is the same as the reliability level of a conventional product, since test time is a factor for determining the cost (M0>M1). The cost of the product with the reliability level C is made much lower than that of the product with the reliability level A which is the same as the reliability level of a conventional product (M0>M1>M2). Such information are registered into test-related file 10 and product information file 13. It is noted that the warranty period, the cost and the malfunction occurrence rate can either be automatically calculated by a software stored in main program file 22, or be externally input via input unit 25.

Thus, the embodiment of the present invention enables selling of a product with moderate reliability, such as “a product available at a low cost even though the reliability thereof is more or less low,” can be sold as demanded by a user.

Only the products that have passed the basic operation test, operation margin test and repair S1, and applied operation test S2 are shipped, so that the basic operation in a normal environment is guaranteed.

A technique for relaxing test conditions or for simplifying the tests, i.e., moderating the reliability compared to a conventional example, includes shortening of screening time by simplifying the contents of the operation test at general and acceleration tests, shortening of test time by aging, or shortening of screening time by changing temperature setting or the like.

As described above, details of the test contents and the test results are respectively registered into items 50 and 51 of test-related file 10. Further, the cost and the test summary are registered into items 33 and 36 of product information file 13.

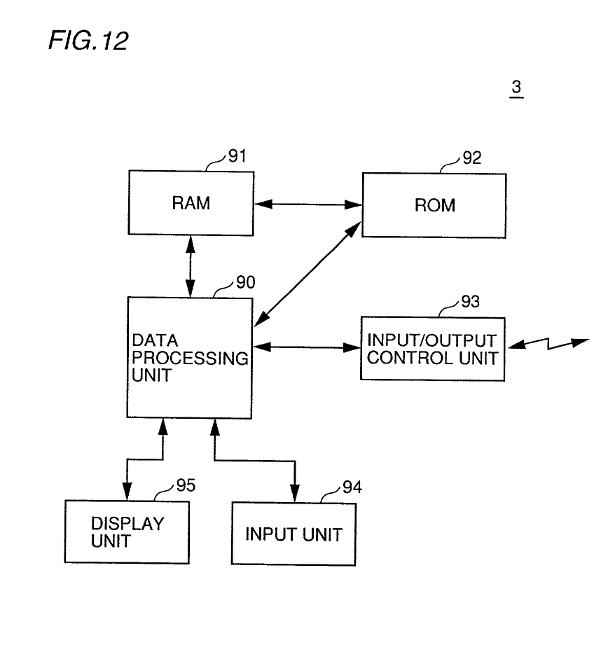

The outline of user terminal 3 is now described with reference to FIG. 12. Referring to FIG. 12, user terminal 3 includes a data processing unit 90 constituted by a CPU (central processing unit), a RAM (random access memory) 91, a ROM (read only memory) 92, an input/output control unit 93 for transmitting/receiving data, an input unit 94 including a keyboard, a mouse or the like, and a display unit 95 for displaying data. Data processing unit 90 processes data using RAM 91, ROM 92, input/output control unit 93, input unit 94 and display unit 95, and transmits/receives data via a network.

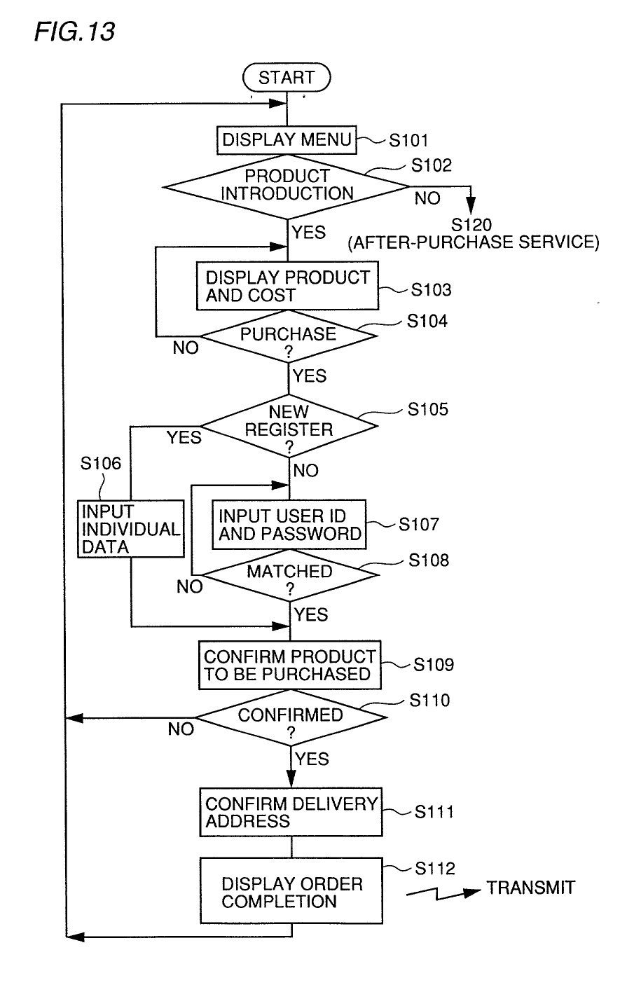

The process flow of a marketing system according to an embodiment of the present invention is described with reference to FIGS. 13 to 17.

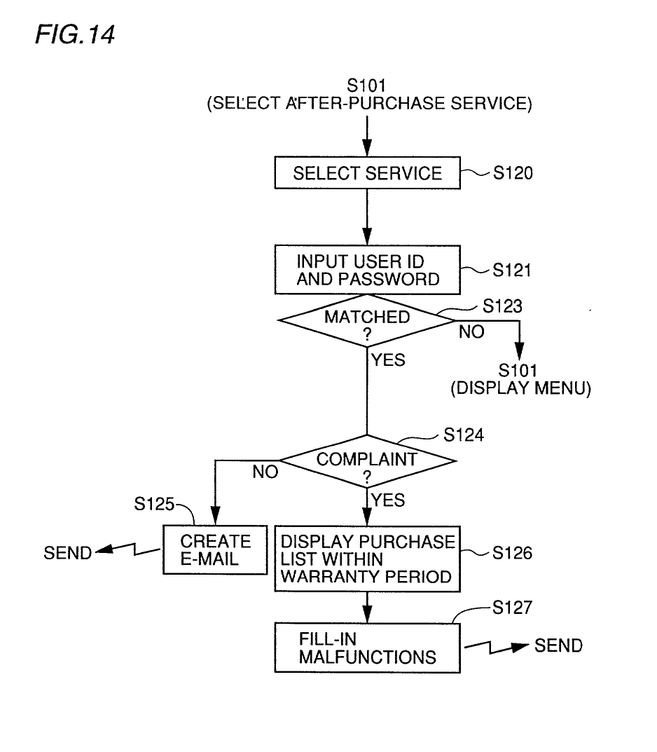

FIGS. 13 and 14 show flow charts illustrating the process flow of the marketing system according to an embodiment of the present invention.

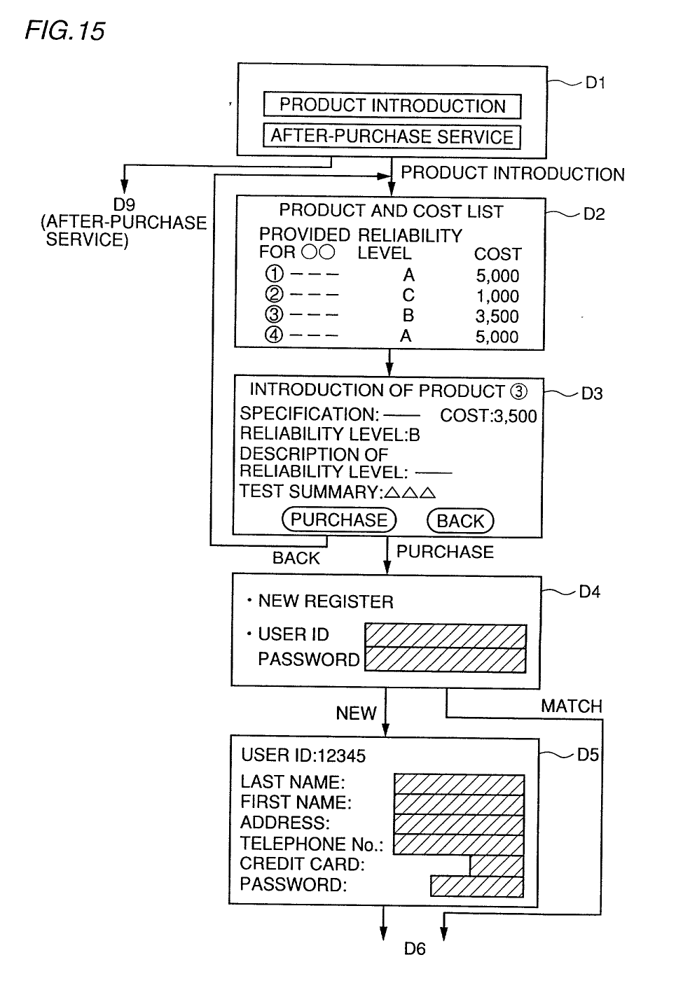

First, when user terminal 3 accesses the Internet 2, a menu display screen Dl shown in FIG. 15 is displayed on display unit 95 (step S101). A user is urged to select if he/she will either see a list of “product introduction” or require “after-purchase service.” Whether or not the “product introduction” is selected is determined (step S102). If the “product introduction” is selected, a product/cost list screen D2 shown in FIG. 15 is displayed on display unit 95 based on the data stored in product information file 13. Screen D2 provides the user with a list of products, reliability levels of the products, costs and so forth.

If the user selects (at the click of a mouse) any of the products displayed on screen D2, a product introduction screen D3 shown in FIG. 15 is displayed on display unit 95. This provides the user with the detailed description of the selected product.

On screen D3, whether or not “purchase” is selected is determined (step S104). If “back” is selected on screen D3, screen D2 is displayed again on display unit 95. If “purchase” is selected on screen D3, a screen D4 shown in FIG. 15 is displayed on display unit 95. Screen D4 urges the user either to select “new register” or, if he/she had already been registered, to enter “a user identification number and a password.”.

Whether or not “new register” is selected is determined (S 105). If it is “new register,” registration screen D5 shown in FIG. 15 is displayed on display unit 95 (step S106). Screen D5 urges the user to enter individual information such as first and last names, an address, a telephone number, a credit card number, a password and so forth. The individual information input form input unit 94 is transmitted to main computer 1 and registered into user registration file 14.

The user who has been registered as a member inputs a user identification number UID and a password from input unit 94 (step S107). Main computer 1 validates the user identification number UID and the password that has been input, based on the data stored in user registration file 14 (step S108). If the user identification number UID and the password do not match with each other, the process goes back to the step urging the entering of user identification number UID and a password (step S107).

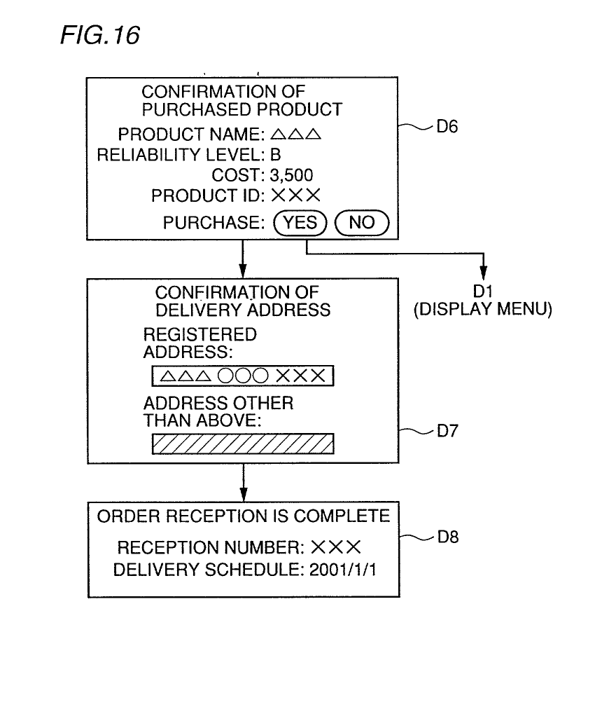

If the member registration is completed and is verified, confirmation of the product to be purchased is displayed (step S109). A confirmation screen D6 for the product to be purchased, shown in FIG. 16, is displayed on display unit 95. Screen D6 provides the user again with the product name, the reliability level, the cost and so forth of the selected product.

Whether “purchase (YES)” or “not purchase (NO)” is selected on screen D6 is determined (step S110). If “purchase (YES)” is selected on screen D6, the user is urged to confirm the delivery address for the product to be purchased (step S111). A delivery address confirmation screen D7 shown in FIG. 16 is displayed on display unit 95 to urge the user to select the delivery address from either the address registered in user registration file 14 or any address other than the registered address. If the user wishes the delivery to an address other than the registered address, he/she follows the instructions on the screen and enters the delivery address via input unit 94.

When the delivery address is confirmed, an order completion screen D8 shown in FIG. 16 is displayed on display unit 95, which notifies the user that the order reception is completed (step S112). Along with the indication of the order completion, information about the purchase order is transmitted to main computer 1 on the maker side.

When “not purchase (NO)” is selected on screen D6 and when the order reception is completed, menu display screen D 1 is displayed on display unit 95.

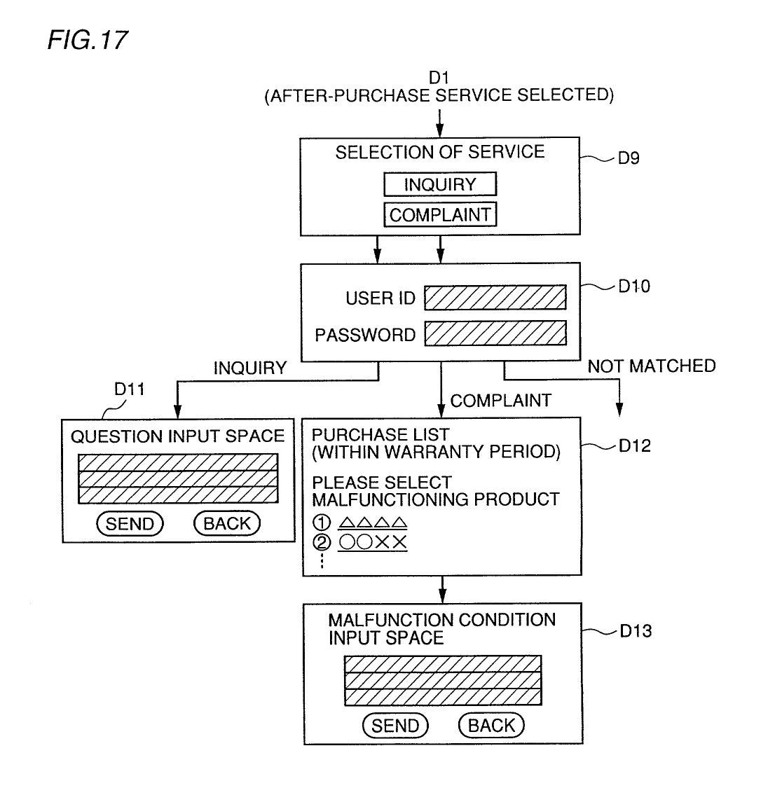

In a case where “after-purchase service” was selected on menu display screen D1, a screen D9 shown in FIG. 17 is displayed on display unit 95, urging the user to select “inquiry” or “complaint” (step S120).

When either one of “inquiry or “complaint” is selected, a screen D10 shown in FIG. 17 is displayed on display unit 95, urging the user to enter a user identification number and a password.

Main computer 1 validates the user identification number UID and the password, based on the data stored in user registration file 14 (step S123). If the user identification number UID and the password do not match with each other, the screen goes back to menu display screen D1.

When the registration is verified, whether “complaint” or “inquiry” is requested is determined (step S124). If the “inquiry” is selected, a screen D11 for creating and transmitting electronic mail is displayed on display 95, as shown in FIG. 17. The e-mail created via input unit 94 is transmitted to main computer 1 side by selecting “send” (step S125). When “back” is selected, the screen goes back to, for example, D1 or D9.

If “complaint” is selected, a purchase list screen D12 shown in FIG. 17 is displayed on display unit 95 (step S126). Screen D12 urges the user to select a malfunctioning product which is purchased by the user and is within a warranty period. Main computer 1 retrieves information concerning the product which is purchased by the user having the input user identification number and the password, and is within the warranty period, from the data stored in purchased-product file 15 and purchase history file 11, and transmits the retrieved data to the user terminal.

If the user selects any product shown in screen D12, a malfunction condition fill-in screen D13 shown in FIG. 17 is displayed on display unit 95. The malfunction condition (complaint information) input by following instructions displayed on display unit 95 is transmitted to main computer 1 by selecting “send” (step S127). The complaint information may be input either in a multiple-choice form or by typing sentences. Main computer 1 determines a process such as a free exchange, depending on each complaint information. When “back” is selected, the screen goes back to, for example, D1, D9 or D12.

The transmitted complaint information is stored into complaint-related file 12. Main computer 1 summarizes and analyzes data for defectives based on the complaint information. The result of the complaint analysis is used to reconfigure the tests.

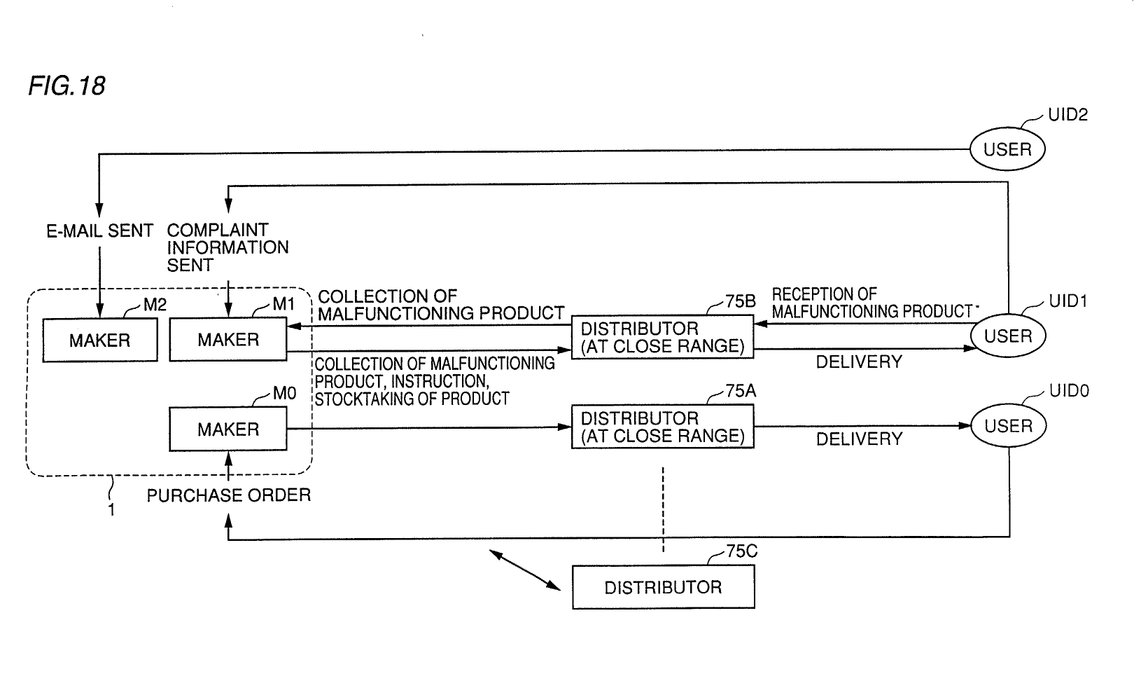

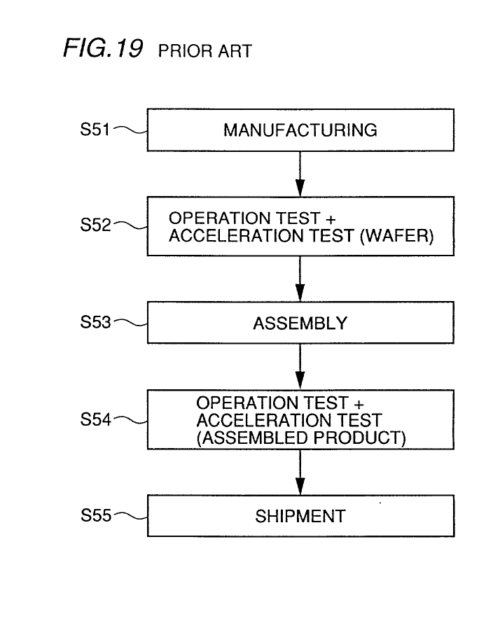

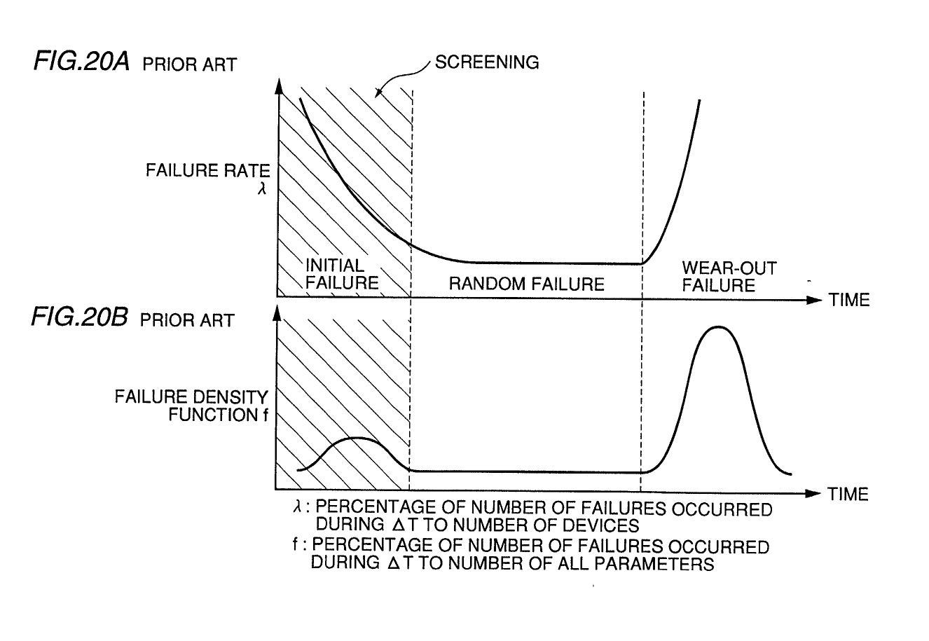

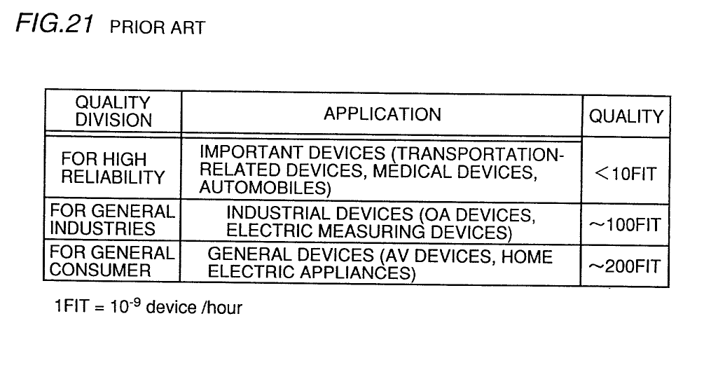

Referring to FIG. 18, makers M0 to M2 construct main computer 1 and share files 10 to 16.

In this case, maker M0 which has received a purchase order from a user UID0 instruct a distributor 75A closest to the delivery address to deliver the product to user UID0.

Maker M1 which has received complaint information from user UID1 confirms the complaint information and then collects a product. Specifically, maker M1 instructs a distributor 75B closest to the address of user UID1 to collect the malfunctioning product. Distributor 75B receives the malfunctioning product from user UID1. The collected malfunctioning product is returned to maker M1. Maker M1 takes stock of an alternative product and send it to distributor 75B, which delivers the alternative product to user UID1. Maker M1 then analyzes the malfunction to reconfigure the tests.

Further, a maker M2 which has received an inquiry via an electronic mail from a user UID2 sends an answer to user UID2 via the electronic mail or the like.

If the contents of complaint-related file 12 indicate that, for example, a product having a lower reliability level compared to a conventional product has less malfunction and is in high demand for the market, the tests will be omitted or simplified.

This enables provision of products at lower cost and quick offer of service.

Though a system flow has been described for a semiconductor product, the embodiment of the present invention is not limited thereto, but rather can be applied to any product (computer or the like) shipped after the tests.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of marketing, comprising the steps of
managing data using an identification number per product;
transmitting grading information concerning said product to a user terminal via a network;
registering a new user as a member;
receiving a purchase order from the user terminal of said user registered as a member via said network; and
reflecting a reaction of the user for said product ordered.

2. The method of marketing according to claim 1, wherein
said grading information includes information indicating a summary of a conducted test, and a reliability level and a cost allocated in accordance with said conducted test.

3. The method of marketing according to claim 2, wherein
said step of managing data includes the steps of
editing a test-related file in which said identification number and information concerning said conducted test are registered per said product, and
editing a product information file in which said identification number and said grading information are registered per said product.

4. The method of marketing according to claim 3, wherein
said step of transmitting grading information concerning said product includes the step of retrieving said product information file in response to a request from said user terminal.

5. The method of marketing according to claim 2, wherein
said step of registering as a member includes the step of allocating an unique user identification number per said user while editing a user management file managing user information per said user identification number.

6. The method of marketing according to claim 2, wherein said step of receiving said purchase order includes the steps of
editing a purchase product file in which an identification number of a product for which said purchase order is received is registered per said user, and
editing a purchase history file in which a warranty period and said identification number are registered per said product for which the purchase order is received.

7. The method of marketing according to claim 6, wherein
said step of reflecting the reaction of the user includes the steps of
receiving complaint information from said user terminal, and
retrieving a history of a product within said warranty period among products ordered by the user who transmitted said complaint information.

8. The method of marketing according to claim 6, wherein
said step of reflecting the reaction of the user includes the steps of
receiving complaint information from said user terminal,
editing a complaint information file based on said complaint information, and
reconfiguring a test conducted on said product using data in said complaint information file.

9. The method of marketing according to claim 1, wherein said reflecting the reaction of the user includes the step of receiving an inquiry from said user terminal.

10. A device for marketing, comprising:
a product management file in which data is registered using an identification number per product;
a product information file in which grading information is registered per said product;
a user registration file in which user information is registered per user identification number;
an input/output control unit for transmitting and receiving data to/from a user terminal via a network; and
a processing unit transmitting data in said product information file to said user terminal, applying said user identification number to a new user, receiving a purchase order from said user terminal of said user to which the user identification is applied, and reflecting a reaction of a user for said product ordered.

11. The device for marketing according to claim 10, wherein
said grading information includes information indicating a summary of a conducted test, and a reliability level and a cost allocated in accordance with said conducted test.

12. The device according to claim 11, further comprising a test-related file, editable with control of said processing unit and to which said identification number and the information concerning said conducted test, are registered.

13. The device for marketing according to claim 11, further comprising:
a purchased-product file, editable with control of said processing unit and to which an identification number of a product for which said purchase order is received, is registered per said user; and
a purchase history file to which a warranty period and said identification number are registered per product for which said purchase order is received.

14. The device for marketing according to claim 13, wherein
said processing unit retrieves a history of a product within said warranty period among products ordered by the user who sent said complaint information, upon reception of said complaint information from said user terminal.

15. The device for marketing according to claim 13, further comprising a complaint information file in which said complaint information transmitted from said user terminal is stored,
said processing unit reconfiguring a test to be conducted for said product using data in said complaint information file.

16. The device for marketing according to claim 11, wherein said processing unit processes for receiving an inquiry from said user terminal to which said user identification number is applied.
